(19) United States
(12) Patent Application Publication
(10) Pub. No.: US 2026/0075367 A1
(43) Pub. Date: Mar. 12, 2026

(54) HEARING AID WITH NOISE-CANCELLATION FUNCTION DESIGNED FOR INSERTION INTO THE EAR

(71) Applicant: OXTI Pte Ltd, Singapore (SG)

(72) Inventor: Chih-Feng Ho, Singapore (SG)

(21) Appl. No.: 18/830,608

(22) Filed: Sep. 11, 2024

(51) Int. Cl. H04R 25/00

(52) U.S. Cl. CPC H04R 25/45; H04R 25/65; H04R 2460/01

(57) ABSTRACT

An in-ear hearing aid with noise cancellation function includes a hearing aid body, a heat dissipation component, a fall prevention component, and an in-ear component. The hearing aid body includes a protective shell, a filter, a main controller, and an output component. The protective shell defines a placement cavity in which the filter, the main controller, and the output component are positioned. The main controller arranged inside the protective shell function to receive signals, which are then processed by the filter and outputted through the output component. The protective shell has an ear canal tube, on which a first assembly block and a second assembly block are mounted. A noise-cancelling rubber sleeve is mounted on the first assembly block, and the in-ear rubber sleeve is mounted on the second assembly block for easy assembly and disassembly, ensuring effective noise cancellation for the in-ear hearing aid.

### BACKGROUND OF THE INVENTION

### Technical Field of the Invention

The present invention relates to the field of hearing aid technology, and more particularly to a hearing aid with noise cancellation function for insertion into a user’s ear.

### Description of the Prior Art

It is well-known that a hearing aid is a small amplifier that magnifies sounds that would otherwise be inaudible, using the residual hearing of a user to transmit the sounds to the brain auditory center to thereby allow for perception of the sounds. This brings significant convenience to people with hearing impairments.

Existing in-ear hearing aids have been found to have several issues during use. They are prone to falling out, making it inconvenient to wear them simultaneously with a mask; they have poor performance of heat dissipation; they do not include filtering devices, making them difficult to clean; their noise reduction effectiveness is poor; and they do not fit well with different ear shapes, leading to high usage limitations.

### SUMMARY OF THE INVENTION

To address the shortcomings of the existing technology, the present invention provides a hearing aid with noise cancellation function insertable into a user’s ear as an in-ear hearing aid.

To achieve the above objective, the present invention provides the following technical solution. An in-ear hearing aid with noise-cancellation function comprises a hearing aid body, a heat dissipation component, a fall prevention component, and an in-ear component. The hearing aid body comprises a protective shell, a filter, a main controller, and an output component. The protective shell defines a placement cavity in which the filter, the main controller, and the output component are positioned. The main controller is connected to the filter and the output component. The fall prevention component is arranged on the protective shell is equipped. The in-ear component is positioned on one side of the protective shell that is adapted to position close to a user’s ear, while the heat dissipation component is positioned on an opposite side of the protective shell that is away from the ear. The in-ear component includes an ear canal tube, a noise-cancelling rubber sleeve, a first assembly block, a second assembly block, and an in-ear rubber sleeve. The ear canal tube is connected, at one end thereof, to the protective shell at the first assembly block, on which the noise-cancelling rubber sleeve is mounted. The second assembly block is mounted on an opposite end of the ear canal tube, and the in-ear rubber sleeve matches with the second assembly block. The output component has an output end that matches the ear canal tube.

To prevent the hearing aid from falling off the ear, the present invention is structured to include a fall prevention component comprising a hinge rod, a hinge frame, and an ear-hanging frame. The hinge frame is positioned atop the protective shell, and one end of the hinge rod is hinged to the hinge frame and an opposite end is connected to the ear-hanging frame.

Furthermore, to ensure comfort for the wearer and facilitate wearing a mask, the present invention is structured such that the ear-hanging frame has a protective pad arranged on one side of the ear-hanging frame that is close to the ear and a guiding groove on one side of the ear-hanging frame that is away from the ear.

To ensure effective heat dissipation, the present invention is structured such that the heat dissipation component comprises a heat dissipation plate and heat dissipation fins. One side of the heat dissipation plate is connected to an inner wall of the protective shell, while an opposite side is mounted with the heat dissipation fins. The side of the protective shell that is away from the ear has a heat dissipation groove, and the heat dissipation component is located within the heat dissipation groove.

To prevent dust accumulating on the heat dissipation component and facilitate cleaning, the present invention is structured to include a dust removal component. The dust removal component comprises a sliding frame, guiding plates, brushes, and a dustproof net. The sliding frame fits with side walls of the heat dissipation groove on two sides thereof. The guiding plates are arranged inside the sliding frame and are respectively equipped with brushes that match with the heat dissipation fins. The dustproof net is arranged on one side of the sliding frame that is away from the ear and matches with the heat dissipation groove.

To facilitate the assembly and disassembly of the sliding frame, the present invention is structured such that the sliding frame is connected with the side walls of the heat dissipation groove through snap-fitting.

Compared to the existing technology, the present invention provides an in-ear hearing aid with noise-cancellation function that provides the following benefits:

The in-ear hearing aid with noise-cancellation function is arranged to set the main controller inside the protective shell to receive signals, which are processed by the filter and then outputted through the output component. The protective shell is equipped with an ear canal tube, which has a first assembly block and a second assembly block. A noise-cancelling rubber sleeve is mounted on the first assembly block, and the in-ear rubber sleeve is mounted on the second assembly block for easy assembly and disassembly, ensuring effective noise reduction.

The hearing aid is designed with a heat dissipation system where the heat dissipation plate in the heat dissipation groove and its connection with the heat dissipation fins further enhance heat dissipation efficiency, ensuring stable operation of the hearing aid. The sliding frame is equipped with a dustproof net for dust protection, and guiding plates with brushes to facilitate cleaning of dust from the heat dissipation fins, further ensuring effective heat dissipation. The sliding frame and heat dissipation groove are designed for ease assembly and disassembly through detachable connection therebetween.

The in-ear hearing aid features interchangeable ear sleeves and noise-cancelling rubber sleeves of various sizes to ensure compatibility with different ear shapes. Additionally, the protective shell is equipped with a hinge frame, with the hinge rod connecting to the ear-hanging frame to prevent the hearing aid from falling off. The ear-hanging frame includes a protective pad for comfort when in contact with the body of a user and a guiding groove to facilitate wearing a mask.

### BRIEF DESCRIPTION OF THE DRAWINGS

FIG. 1 is a schematic view showing a structure of the present invention;

FIG. 2 is a schematic view, in a sectioned form, showing the structure of the present invention; and

FIG. 3 is a side view showing the structure of the present invention.

### DETAILED DESCRIPTION OF THE PREFERRED EMBODIMENTS

The following provides a clear and complete description of the technical solution of the present invention based on the accompanying drawings with reference to embodiments of the present invention. It is evident that the described embodiments are only a part of the embodiments of the present invention, not all of them. All other embodiments obtained by those skilled in the art without inventive effort fall within the protection scope of the present invention.

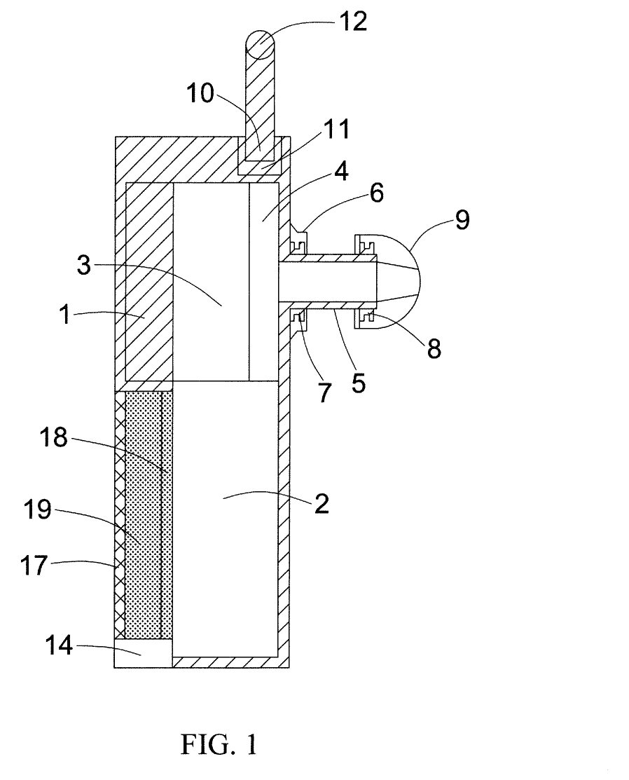

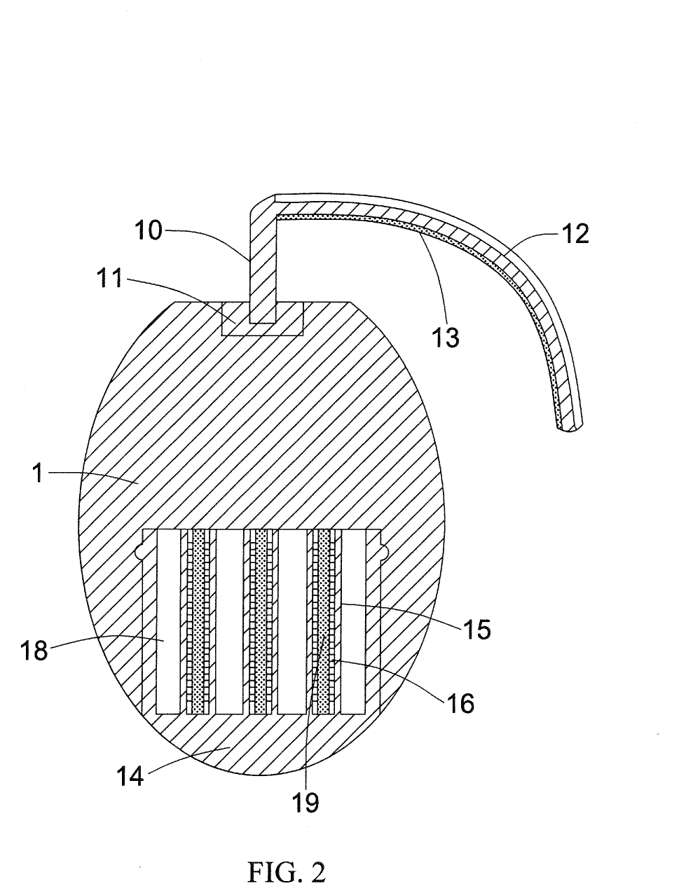

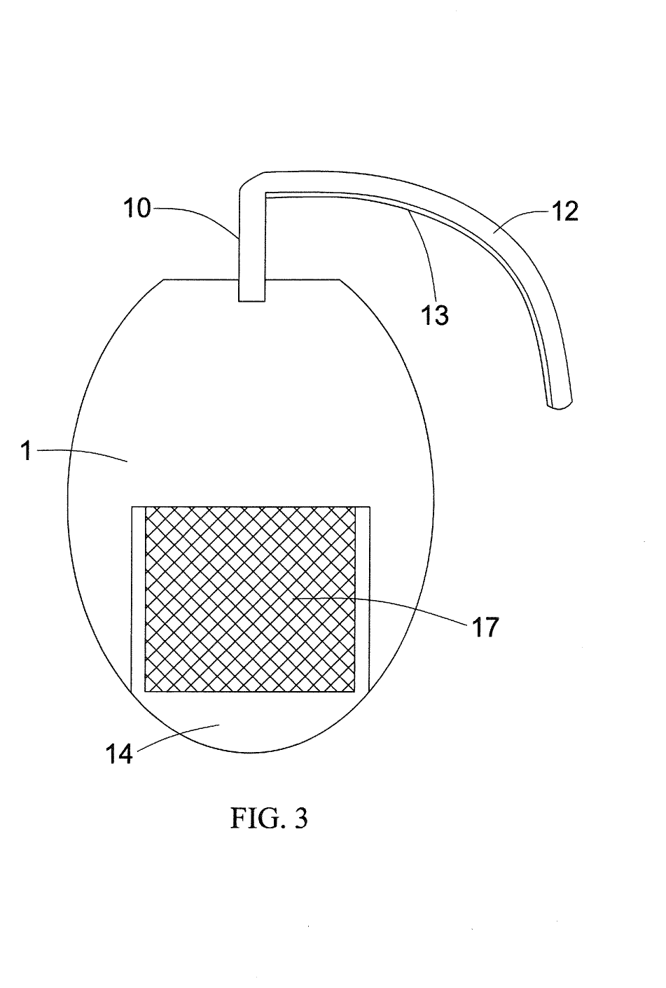

Referring to FIGS. 1-3, the present invention provides a hearing aid with noise-cancellation function designed for insertion into an ear of a user to serve as an in-ear hearing aid, specifically a noise-cancelling in-ear hearing aid. The in-ear hearing aid includes a hearing aid body, a heat dissipation component, a fall prevention component, and an in-ear component. The hearing aid body comprises a protective shell (1), a filter (2), a main controller (3), and an output component (4). The protective shell (1) defines a placement cavity in which the filter (2), main controller (3), and output component (4) are arranged. The main controller (3) is connected to the filter (2) and the output component (4). The protective shell (1) is equipped with the fall prevention component. One side of the protective shell (1) that is adapted to position close to the ear of the user is fitted with the in-ear component, while an opposite side that is away from the ear of the user has the heat dissipation component. The in-ear component comprises an ear canal tube (5), a noise-cancelling rubber sleeve (6), a first assembly block (7), a second assembly block (8), and an in-ear rubber sleeve (9). The ear canal tube (5) is connected, at one end thereof, to the protective shell (1) at the first assembly block (7), which is equipped with the noise-cancelling rubber sleeve (6). An opposite end of the ear canal tube (5) has the second assembly block (8), and the in-ear rubber sleeve (9) matches with the second assembly block (8). The output component (4) has an output end that matches with the ear canal tube (5).

The fall prevention component includes a hinge rod (10), a hinge frame (11), and an ear-hanging frame (12). The hinge frame (11) is positioned on a top of the protective shell (1), and the hinge rod (10) has one end hinged to the hinge frame (11) and an opposite end connected to the ear-hanging frame (12) to prevent the in-ear hearing aid from falling off the ear.

The ear-hanging frame (12) has a protective pad (13) arranged on one side of the ear-hanging frame that is close to the ear and a guiding groove on one side of the ear-hanging frame that is away from the ear, in order to further ensure wearer comfort and facilitate mask wearing.

The heat dissipation component includes a heat dissipation plate (18) and heat dissipation fins (19). One side of the heat dissipation plate (18) is connected to an inner wall of the protective shell (1), while an opposite side is equipped with the heat dissipation fins (19). The side of the protective shell (1) away from the ear has a heat dissipation groove, within which the heat dissipation component is located to ensure effective heat dissipation.

The protective shell (1) has a dust removal component, including a sliding frame (14), guiding plates (15), brushes (16), and a dustproof net (17). The sliding frame (14) fits with side walls of the heat dissipation groove on two sides thereof. The guiding plates (15) are arranged inside the sliding frame (14), and the guiding plates are respectively equipped with brushes (16) that match with the heat dissipation fins (19). The dustproof net (17) is arranged on one side of the sliding frame (14) that is away from the ear and matches with the heat dissipation groove to prevent dust accumulation on the heat dissipation component and facilitate cleaning.

The sliding frame (14) is snap-fitted with the side walls of the heat dissipation groove to facilitate assembly and disassembly.

In summary, the in-ear hearing aid with noise cancellation function ensures that during use, the main controller (3) inside the protective shell (1) receives signals, which are processed by the filter (2) and then outputted through the output component (4). The protective shell (1) is equipped with an ear canal tube (5) having a first assembly block (7) and a second assembly block (8). The noise-cancelling rubber sleeve (6) is placed on the first assembly block (7), and the in-ear rubber sleeve (9) is placed on the second assembly block (8) for easy assembly and disassembly, ensuring effective noise reduction. The in-ear hearing aid dissipates heat through the heat dissipation plate (18) arranged in the heat dissipation groove, and the heat dissipation plate (18) is connected to the heat dissipation fins (19) to improve heat dissipation efficiency and ensure stable operation. The sliding frame (14) is equipped with a dustproof net (17) for dust protection, and the guiding plates (15) are provided with the brushes (16) to facilitate cleaning of dust from the heat dissipation fins (19), ensuring effective heat dissipation. The sliding frame (14) and heat dissipation groove have an arrangement of detachable connection therebetween for easy assembly and disassembly. The noise-cancelling rubber sleeve (6) can be made is in various sizes to ensure compatibility with different ear shapes. Additionally, the protective shell (1) is equipped with a hinge frame (11) connected by a hinge rod (10) to an ear-hanging frame (12) to prevent the hearing aid from falling. The ear-hanging frame (12) has a protective pad (13) for comfort and a guiding groove for easy mask wearing.

Although the embodiments of the present invention have been shown and described, those skilled in the art will understand that various modifications, changes, substitutions, and variations can be made without departing from the principles and spirit of the present invention. The scope of the present invention is defined by the appended claims and their equivalents.

I claim:

1. A noise-cancelling in-ear hearing aid, comprising a hearing aid body, a heat dissipation component, a fall prevention component, and an in-ear component, wherein the hearing aid body comprises a protective shell, a filter, a main controller, and an output component, wherein the protective shell defines a placement cavity in which the filter, the main controller, and the output component are arranged; the main controller is connected to the filter and the output component; the fall prevention component is arranged on the protective shell; the in-ear component is positioned on one side of the protective shell that is adapted to position close to a user’s ear, and the heat dissipation component is positioned on an opposite side of the protective shell that is away from the ear; the in-ear component comprises an ear canal tube, a noise-cancelling rubber sleeve, a first assembly block, a second assembly block, and an in-ear rubber sleeve, wherein the ear canal tube is connected, at one end thereof, to the protective shell at the first assembly block, the noise-cancelling rubber sleeve being mounted on the first assembly block, the second assembly block being mounted to an opposite end of the ear canal tube, the in-ear rubber sleeve matching with the second assembly block; and the output component has an output end matching with the ear canal tube.

2. The noise- cancelling in-ear hearing aid according to claim 1, wherein the fall prevention component comprises a hinge rod, a hinge frame, and an ear-hanging frame, the hinge frame being positioned atop the protective shell, one end of the hinge rod being hinged to the hinge frame, an opposite end of the hinge rod being connected to the ear-hanging frame.

3. The noise- cancelling in-ear hearing aid according to claim 2, wherein the ear-hanging frame has a protective pad arranged on one side of the ear-hanging frame that is close to the ear and a guiding groove on one side of the ear-hanging frame that is away from the ear.

4. The noise- cancelling in-ear hearing aid according to claim 3, wherein the heat dissipation component comprises a heat dissipation plate and heat dissipation fins, one side of the heat dissipation plate being connected to an inner wall of the protective shell, an opposite side of the heat dissipation plate being provided with the heat dissipation fins, the side of the protective shell that is away from the ear has a heat dissipation groove, within which the heat dissipation component is located.

5. The noise- cancelling in-ear hearing aid according to claim 4, wherein the protective shell is equipped with a dust removal component, which comprises a sliding frame, a guiding plate, a brush, and a dustproof net, the sliding frame fitted with side walls of the heat dissipation groove on two sides thereof, the guiding plate being arranged in the sliding frame, the brush being arranged on the guiding plate to match with the heat dissipation fins, the dustproof net being arranged on one side of the sliding frame that is away from the ear and matches with the heat dissipation groove.

6. The noise- cancelling in-ear hearing aid according to claim 5, wherein the sliding frame is connected with the side walls of the heat dissipation groove through snap-fitting.
